(19) United States
(12) Patent Application Publication
(10) Pub. No.: US 2005/0070285 A1
(43) Pub. Date: Mar. 31, 2005

(54) Handover for use with adaptive antennas

(75) Inventor: Bo Goransson, Stockholm (SE)

Correspondence Address: NIXON & VANDERHYE, PC, 1100 N GLEBE ROAD, 8TH FLOOR, ARLINGTON, VA, 22201-4714, US

(73) Assignee: Telefonaktiebolaget LM Ericsson (publ), Stockholm (SE)

(21) Appl. No.: 10/671,882

(22) Filed: Sep. 29, 2003

(51) Int. Cl. H04Q 7/20

(52) U.S. Cl. 455/436; 455/438

(57) ABSTRACT

Handover procedures take into account adaptive antennas that employ narrow, directional antenna beams. A connection is established with a mobile station by way of an originating radio base station. Downlink signal quality measurements associated with cell-wide transmissions from neighboring base stations are detected by the mobile station and reported to the radio network. The handover target base station is determined based upon those signal quality measurements. A desired antenna beam at the target base station is also determined for communicating with the mobile station based on uplink measurements made by the target base station. A handover connection is established between the target base station and the mobile station using the desired antenna beam at the target base station.

### BACKGROUND OF THE INVENTION

The present invention relates to mobile radio communications, and in particular, to mobile radio communications systems that support diversity handover.

In a code division multiple access (CDMA) mobile communications system, spreading codes are used to distinguish information associated with different mobile stations or base stations transmitting over the same radio frequency band. In other words, individual radio “channels” correspond to and are discriminated on the basis of these spreading codes. Spread spectrum (e.g., CDMA) communications permit mobile transmissions to be received at two or more (diverse) base stations and be processed simultaneously to generate one received signal as well as signals from multiple base stations to generate one received signal in the mobile.

Because of these combined signal processing capabilities, it is possible to perform a handover of a mobile call from one base station to another base station, or from one antenna sector to another antenna sector connected to the same base station, without any perceptible disturbance in the voice or data communications. In a contrast to “hard” handovers where the connections is momentarily broken while it is transferred to a new base station, this make-before-break handover is sometimes called “soft” handover or “diversity” handover. The term soft handover (SHO) includes soft handover between base stations and soft handover between base station sectors.

In older cellular systems, each base station typically services one overall coverage area called a site. One or more omni-directional antennas service the entire site area. But in more modern cellular systems, the site area may be divided up into smaller areas called sector cells or simply cells. One or more antennas service each sector cell. FIG. 1A illustrates a sector cell antenna beam. Because the entire site area need not be covered and the sector antenna(s) need only reach mobile in one sector, sector transmissions can be at a lower power.

Although a sector antenna is useful to communicate broadcast and/or control information to all mobiles in the sector cell, an adaptive antenna may be used to transmit and receive in narrow beams covering just a part of the sector cell. FIG. 1B shows an example narrow antenna beam transmitted from an adaptive antenna at the base station encompassing a relatively narrow area in the sector cell where a mobile station is located. Adaptive antenna beams include one or more different types of beams. FIG. 2 illustrates a cellular network with a base station transmitting a sector beam, a base station transmitting one of the possible beams in a multibeam system, and a base station transmitting a steerable beam. Some benefits of adaptive antennas are shown in FIG. 3 in the context of a TDMA/GSM system. In a TDMA system, mobile users with the same frequency and time slot are located in adjacent or nearby cells, and thus, the effect of transmitted/received signals to/from those adjacent cells should be limited. The narrow beam of the adaptive antenna is directed to the intended mobile and therefore spreads less interference in the downlink direction. The narrow beam suppresses spatial interference from the adjacent cell interferers in the uplink direction. Both factors increase the signal-to-interference gain in both uplink and downlink directions, and therefore, increase overall system performance.

During diversity handover, the signaling and voice information from plural sources is combined in a common point using decisions made on the “quality” of the received data. Reference is made to FIG. 4 useful in understanding example cell-to-cell handover procedures. A mobile station 20 begins a call using a connection with base station BS1. The mobile 20 also measures the signal strength or quality of pilot signals received from adjacent cells, e.g., signal-to-interference ratio (SIR), in this case exemplified by base station BS2. The mobile 20 reports these SIR measurements to the radio network controller (RNC)/base station controller (BSC) 14 that is coupled to both BS1 and BS2. When the SIR detected for BS2's common pilot exceeds a threshold, a second connection is established for the call between BS2 and the mobile 20. The RNC 14 puts both BS1 and BS2 in this mobile's “active” set. The mobile continues to monitor the SIR from neighboring base stations to determine potential, active-set candidates. A candidate list may also be maintained for the mobile. The RNC 14 updates the active set and any candidate list based on those SIR measurements.

A problem arises in handover situations where a neighboring sector cell to which a handover connection is to be or may be established employs one or more adaptive antennas. Mobile's detect and measure the signal quality of a sector pilot or other broadcast signal, e.g., the primary common pilot channel (P-CPICH) in a third generation WCDMA cellular system (e.g., 3GPP). On the other hand, a mobile uses a different pilot signal when an active connection is established between a mobile and a sector cell antenna beam in order to attain the necessary timing to demodulate the received dedicated traffic channel, e.g., the secondary common pilot channel (S-CPICH) in a third generation (3GPP) WCDMA cellular system. But when the RNC 14 commands the target base station BS2 to issue a new radio link as part of the handover operation, the target base station has no knowledge of which phase reference out of possibly many phase references to use for the new radio link.

Consider this problem specifically in the context of a WCDMA type system. The Primary Common Pilot Channel (P-CPICH) in WCDMA must cover the whole cell (it actually defines the cell). When a radio link is transmitted in a narrow beam, another pilot is needed because the physical radio channel associated with the sector beam primary pilot may be different from the radio channel associated with a narrow antenna beam. Such radio channel differences between wide and narrow antenna beams are due to propagation effects such as scattering and reflections that may occur in the environment. For example, there may be a large building in one part of the cell that reflects the radio waves if they are transmitted towards the building. That reflection always occurs for the wide beam transmitted with the sector-covering antenna but may only occur for some of the narrow beams depending on where each is directed. A radio link transmitted over a narrow beam therefore requires another phase reference (pilot) to allow the mobile to estimate the radio channel associated with that narrow beam and to use this channel estimate when it demodulates the received signal. Because a secondary common pilot (like the S-CPICH in WCDMA) does not need to be transmitted in the whole cell, it can be used in a narrow beam.

All measurements related to hand over are made on the primary pilot, (e.g., the P-CPICH), which means that the radio network (e.g., the RNC in WCDMA) does not have any information about where (in which narrow beam) the mobile is located when the new radio link is established. As a result, the radio network can not tell the mobile which secondary pilot channel (S-CPICH in WCDMA) to use as a phase reference. The radio link must therefore be transmitted on a sector covering antenna since the primary pilot (P-CPICH in WCDMA) is the only known phase reference for the mobile.

### SUMMARY OF THE INVENTION

Handover procedures are described which take into account adaptive antennas that employ narrow, directional antenna beams. A connection is established with a mobile station by way of an originating radio base station. Downlink signal quality measurements associated with broadcast transmissions from neighboring base stations are detected by the mobile station and reported to the radio network. A target base station for handover of the mobile station connection is determined based upon one or more of those signal quality measurements. In addition, the target base station make uplink measurements associated with the mobile station, and a desired, narrow antenna beam at the target base station is determined based on those uplink measurements. A handover connection is established between the target base station and a mobile station that ultimately uses the desired antenna beam at the target base station.

In one non-limiting, example, embodiment, a radio link is established between the target base station and the mobile station using a common broadcast signal or an ordinary dedicated channel transmitted cell-wide using the target base station's sector cell antenna. The desired antenna beam is thereafter determined using the uplink measurement information from the target base station, and the radio link is reconfigured to the desired antenna beam. The radio link is initially configured using a first phase reference associated with the cell-wide signal. When the radio link is reconfigured, it uses a second phase reference associated with the desired antenna beam.

But in a preferred, non-limiting, example embodiment, a specific antenna beam at the target base station is determined for the mobile station connection (before link set-up) using uplink measurement information from the target base station. As a result, the handover radio link between the desired antenna beam and the mobile station. Reconfiguration of the handover link is unnecessary is set up from the start.

The target base station employs one or more first antennas for transmitting the common broadcast or other cell-wide signal using a wide antenna beam. The signal quality of the received broadcast or other cell-wide signal is detected by mobile stations for purposes of providing downlink signal quality signal messages. The target base station further includes one or more second antennas for transmitting other types of signals using a narrower antenna beam. Preferably, the desired antenna beam covers an area where the mobile station is located or where the mobile station is predicted to be located. Alternatively, the desired antenna beam covers an area closest to where the mobile station is currently located or where the mobile station is predicted to be located. Although in the example implementations the handover is a soft handover, the invention may also be applied to a hard handover.

Several advantages flow from the present invention. First, because the handover radio link is established specifically for a narrow antenna beam, the radio transmission is more efficient. Second, there is less interference spread in the system and less transmit power required to communicate with the mobile station. Third, less interference and transmit power ultimately results in increased overall system performance. Fourth, radio resource management algorithms may be based upon resources allocated per antenna beam rather than resources allocated for the entire sector cell. As a result, the RNC can better control the resources in the system. For example, one part of the cell (one or a few beams) maybe overloaded while other parts are virtually unloaded. This situation can not be detected by sector measurements alone since they will show some kind of cell average. So, if the load control is beam-level based, better granularity and higher capacity is achieved. Fifth, because the radio link is established directly to the most favorable antenna beam for the mobile to receive information from the target base station, a higher quality signal connection is achieved. With the preferred example embodiment that does not require link reconfiguration, the handover radio link is established faster using less signalling over the radio air interface than in typical handover procedures. The load on the radio network, (e.g., the RNC in WCDMA), will be lower because the reconfiguration uses computing power in the network.

### BRIEF DESCRIPTION OF THE DRAWINGS

FIG. 1A illustrates a sector cell and a sector antenna beam broadcast by a base station;

FIG. 1B illustrates a sector cell with a narrow directional beam that covers only a portion of the sector cell;

FIG. 2 illustrates a sector antenna beam, a multi-beam, and a steerable beam;

FIG. 3 illustrates an adaptive array antenna with a directional beam communicating with a desired mobile station without interfering with other mobiles;

FIG. 4 shows a handover in a radio communications system;

FIG. 5 illustrates a radio communications system in which at least one base station employs an adaptive antenna;

FIG. 6 illustrates in function block form a base station with adaptive antennas;

FIG. 7 is a flow chart diagram illustrating example adaptive antenna handover procedures;

FIG. 8 is a flow chart diagram illustrating handover procedures in accordance with a first example embodiment; and

FIG. 9 is a flow chart diagram illustrating handover procedures in accordance with a preferred, example embodiment.

### DETAILED DESCRIPTION

For purposes of explanation and not limitation, the following description sets forth specific details, such as particular electronic circuitry, procedures, techniques, etc., in order to provide an understanding of the present invention. But it will be apparent to one skilled in the art that the present invention may be practiced in other embodiments that depart from these specific details. In other instances, detailed descriptions of well-known methods, devices, and techniques, etc., are omitted so as not to obscure the description with unnecessary detail. Individual function blocks are shown in one or more figures. Those skilled in the art will appreciate that functions may be implemented using discrete components or multi-function hardware. The processing functions in particular may be implemented using a programmed microprocessor or general-purpose computer, using an application specific integrated circuit (ASIC), and/or using one or more digital signal processors (DSPs).

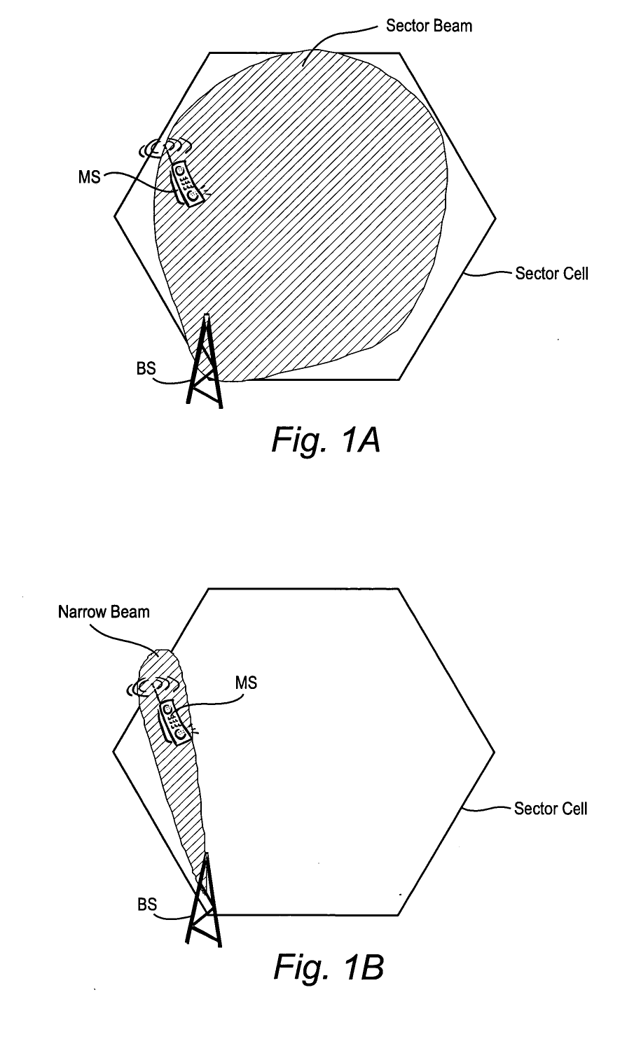

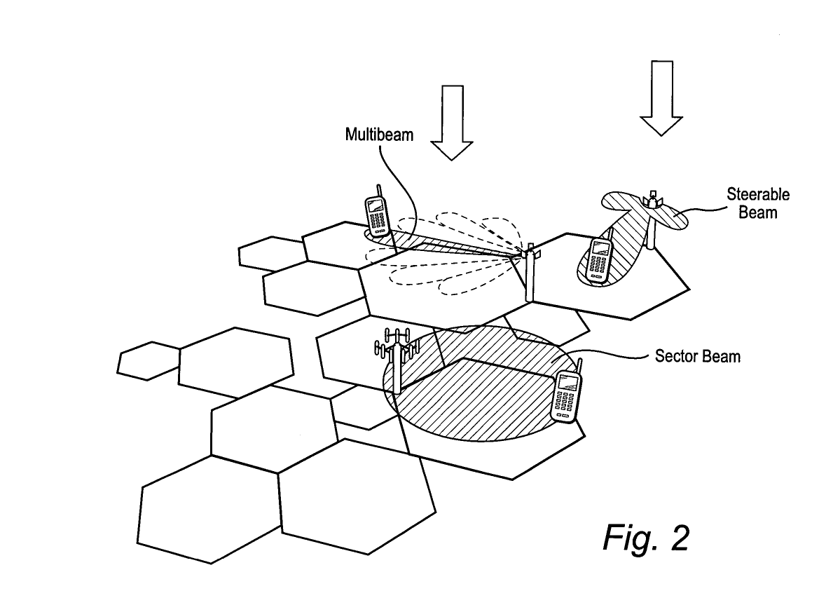

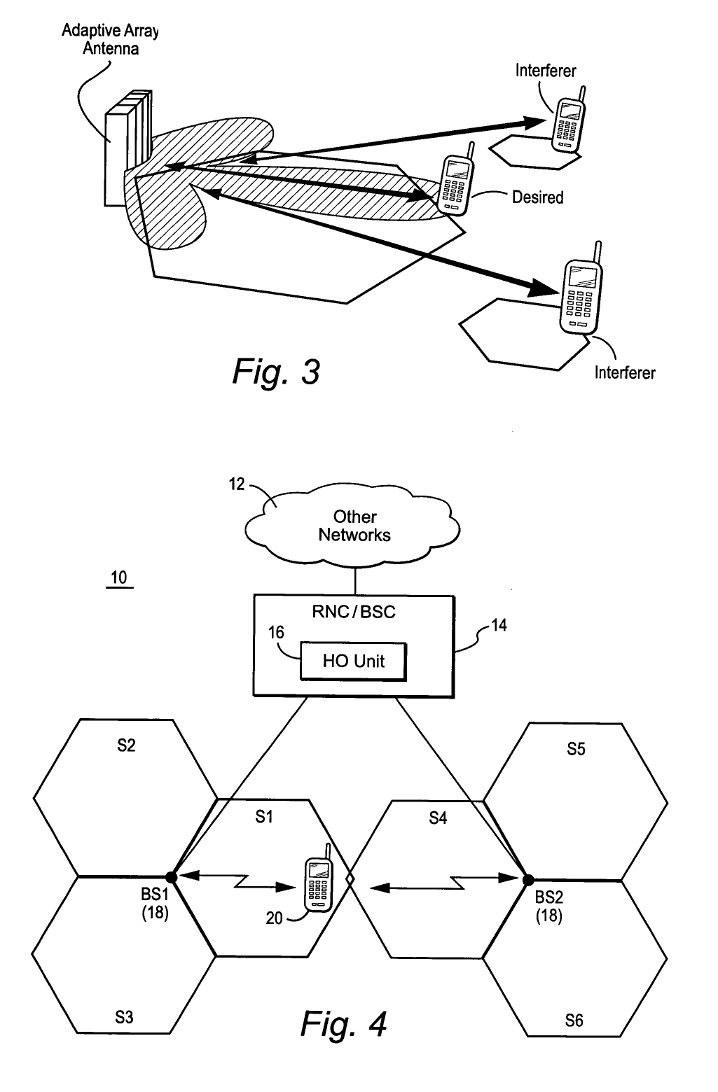

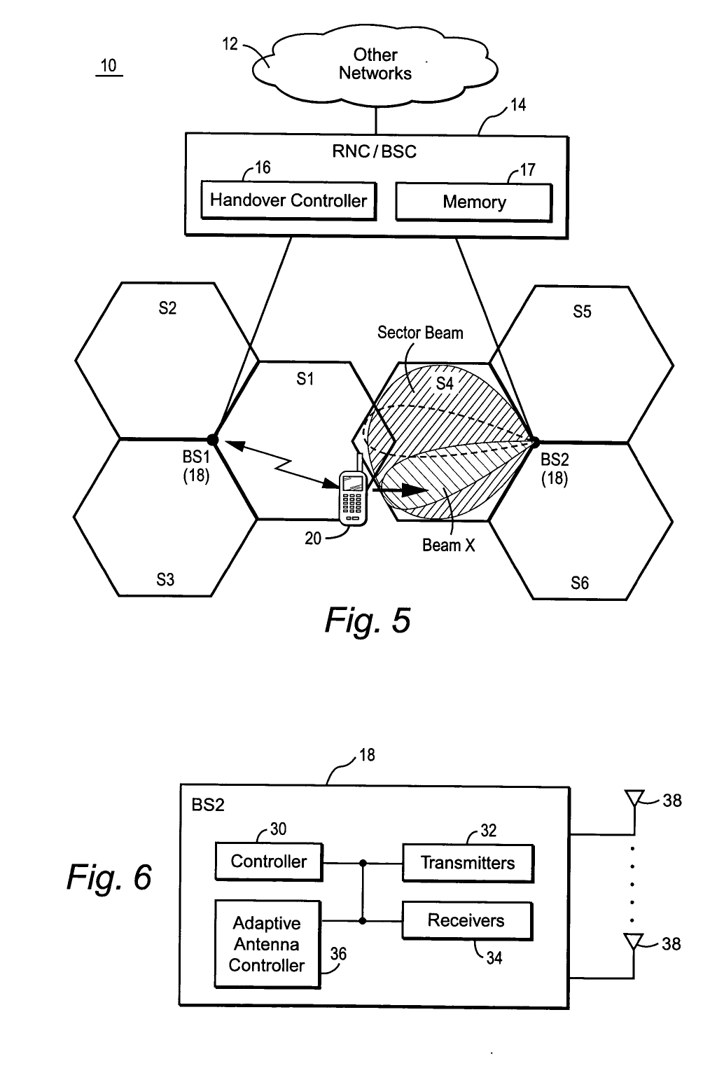

FIG. 5 illustrates a radio communications system 10 that includes a radio network controller (RNC)/base station controller (BSC) 14 coupled to representative base stations (BS1) and (BS1) identified by reference numeral 18. The RNC/BSC 14 is also coupled to one or more other networks represented by cloud 12. The RNC/BSC 14 includes, among other things, a handover controller 16 and a memory 17 for storing signal quality information used in handover decision making procedures. Base station BS1 divides its coverage into three representative sectors S1, S2 and S3. Base station BS2 similarly divides its coverage into three sectors S4, S5, and S6. Each sector has one or more antennas. In FIG. 5, at least base station BS2 includes one or more adaptive antennas. In this example, sector S4 includes a sector beam antenna for broadcasting common information such as a pilot signal. Other cell-wide signals may be employed. One example pilot signal could be that described in the background—a primary CPICH channel. Of course, other common signals may be broadcast over the sector antenna. Sector S4 also includes a multi-beam and/or steerable beam antenna such that one or more narrow antenna beams are/may be directed to a particular portion of the sector cell. An example of a narrow antenna beam is shown in FIG. 1B. A sector beam is shown in both FIGS. 1A and 2, and a multi-beam and a steerable beam are shown in FIG. 2. A mobile station 20 has an active radio link with base station BS1 and is moving toward a portion of sector 4 of base station BS2 covered by narrow antenna beam X. That movement prompts a handover to sector S4.

Base station BS2 is shown in further detail in FIG. 6 in function block diagram format. A supervisory controller 30 is coupled to an adaptive antenna controller 36, multiple transmitters 32, and multiple receivers 34. The multiple transmitters and receivers are coupled by way of conventional filter and duplexing circuitry to adaptive antennas 38. The fixed beams (multi-beam) may be generated either at the antennas by a beamforming network, e.g., a Butler matrix, or at baseband by applying different weight factors to each transmit branch. Steerable beams are generated with baseband processing. The adaptive antenna controller 36 generates weight factors using a suitable beamforming algorithm. A variety of different beamforming algorithms are well known to those skilled in this art.

Although the present invention may be applied to any handover procedure including both hard handover and soft handover, a soft handover situation as set forth in the context of a third generation, WCDMA, cellular system (e.g., 3GPP) is described below for purposes of illustration. A complete description of 3GPP handover procedures and parameters may be found in 3GPP Technical Specification (TS) 25.433 UTRAN Iub Interface NBAP signaling and TS 25.423 UTRAN Iur Interface RNSAP signaling. Signal quality measurements involved in handover decision making procedures are described in TS 25.215 Physical Layer Measurements, and TS 25.214 Physical layer procedures (FDD) describe the power control aspects relating to handover. . . . In addition radio resource control operations such as radio link addition/removal, active set update, etc, are described in TS 25.331 Radio Resource Control (RRC) Protocol Specification.

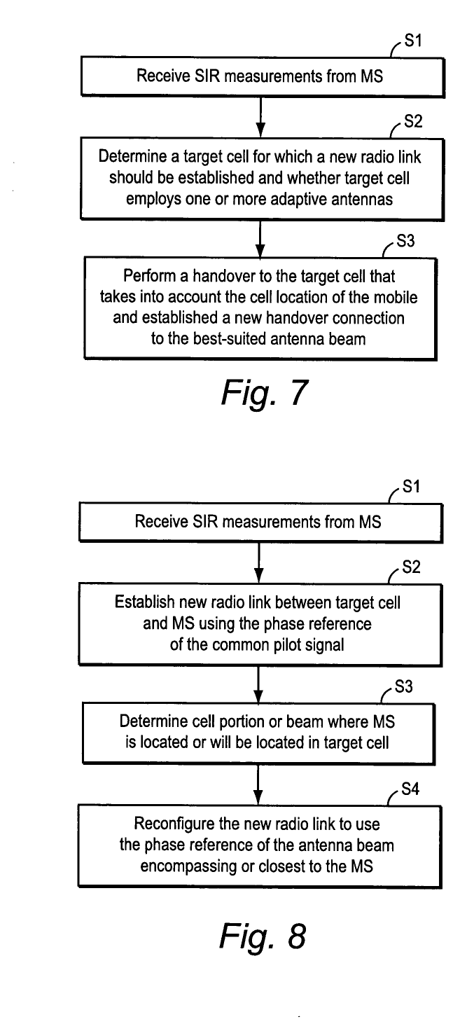

Referring to the flow chart diagram in FIG. 7, the RNC 14 receives signal quality measurements reported from mobile stations for downlink common pilot transmissions received from neighboring base stations (step S1). The common pilot signals from neighboring base stations are transmitted using sector antennas over, for example, a primary common pilot type of channel such as the P-CPICH. The P-CPICH is associated with a pre-defined spreading code with a known bit pattern. The signal quality measured by the mobile stations could be, for example, signal-to-interference ratio (SIR). The signal quality measurements are relayed to the RNC and stored in memory 17.

When a pilot signal quality received from a neighboring base station, in this example base station BS2, exceeds a predetermined threshold or other criterion/criteria for handover, the handover controller 16 identifies that neighboring base station sector cell as a target cell for which a new radio link should be established (step S2). The handover controller 16 also determines whether the target sector cell employs one or more adaptive antennas as support now antenna beams for supporting traffic communications over the radio interface. The handover is performed to the target sector cell, in this example sector S4, taking into account the cell location of the mobile station (step S3). (Typically, the handover controller 16 is not aware of the mobile's current or predicted location in the target cell when the new radio link needs to be established. But this problem is solved by the present invention as explained below.) A new radio link is ultimately established for the handover to the antenna beam best-suited or otherwise desired to support this handover connection. In the example FIG. 5, that best-suited antenna beam is beam X which covers the sector 4 cell location where the mobile station currently is or is expected to be. Alternatively, the sector 4 beam may be selected which is closest to where the mobile currently is or is expected to be.

Two, nonlimiting, example embodiments for implementing a handover to an adaptive antenna beam are now described. FIG. 8 illustrates a flow chart detailing first, non-limiting, example embodiment procedures. The signal quality measurements for the downlink base station sector beam transmissions are reported to the RNC from the mobile stations (step S1). When the target base station sector has been identified from the signal quality measurements, a handover radio link is established between the target sector cell and the mobile station using the phase reference of the common pilot signal (step S2). The pilot (or phase reference) is used for channel estimation and also for estimating the signal quality, e.g., signal-to-interference ratio (SIR), experienced by the mobile terminal. The RNC or target base station determines the cell portion or narrow beam antenna where the mobile station is located or will be located in the target sector cell (step S3).

One or more different parameters could be used to determine the location of the mobile station and/or which beam is best-suited or otherwise desired for the handover connection. For example, one or more available power or quality measurements, such as SIR, RSSI (Received Signal Strength Indicator), or other power or quality measurements may be used to determine the mobile's location and/or select the desired beam. Having the target base station measure and report to the RNC one or more such parameters based on uplink signals from the mobile station, e.g., estimating the received SIR in each of the fixed antenna beams at the target base station provides the RNC handover controller 16 sufficient information to select the desired beam for the handover. Alternatively, the target base station may simply estimate the direction towards the mobile using an adaptive antenna and provide this information to the handover controller 16 in the RNC. In this example, SIRs associated with each target base station beam are used, and the handover controller 16 selects the antenna beam (cell portion) with the highest SIR as the desired beam. Furthermore, the RNC may apply admission control to check for available resources in that beam (direction). The handover radio link is then reconfigured to use the phase reference associated with the selected narrow antenna beam (step S4).

The first example embodiment requires that the handover radio link be established using a sector cell antenna beam pattern optimized for transmission over the entire sector cell rather than just a portion of the cell. As a result, unnecessary interference is generated. This first handover procedure also suffers from some delay since the new radio link must be configured twice. Another drawback with the first embodiment is that if radio resource management (RRM) is performed by the RNC based on cell portion measurements, e.g., the RRM is done on an individual, narrow beam basis, the new radio link could be added initially for the sector cell even though that cell may not have sufficient resources at the particular cell portion where the mobile station is or will be located.

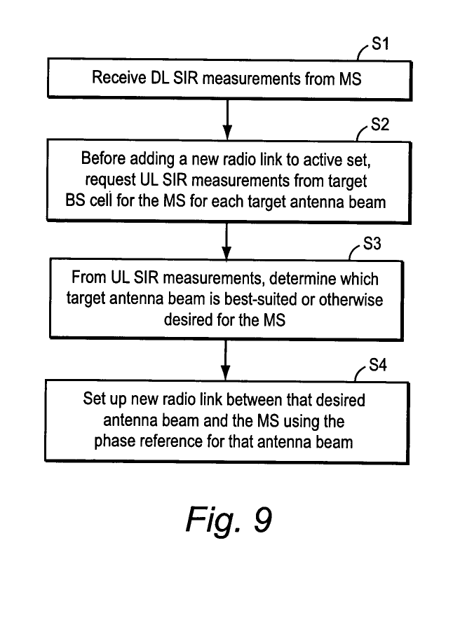

The second, preferred (but still example) embodiment overcomes these drawbacks. Referring to FIG. 9, the RNC collects signal quality measurements made by mobile stations based upon downlink, common pilot transmissions from neighboring base stations (step S1). But before adding a new radio link to the active handover set for mobile station 20, the RNC requests uplink signal quality measurements from the target base station cell for the mobile station for each target antenna beam in that base station cell (step S2). From the uplink signal quality measurements, the RNC determines which target antenna beam is best-suited or otherwise desired for the handover (step S3). The RNC then sets up a new radio link between that desired antenna beam and the mobile station using the phase reference for that desired, narrow antenna beam (step S4). The RNC will allocate the secondary pilot that corresponds with the best-suited cell portion. This information will also be reported to the base station so that the base station can transmit the radio link in the appropriate beam. From the SIR measurements, (see 3GPP TS 25.215), the RNC may decide which cell portion is best-suited for a connection with the mobile station. Once that desired cell portion/antenna beam has been identified, the handover radio link set up proceeds as normal. Because the RNC is aware of the “position” of the mobile station, the correct phase reference is used in the initial radio link set up, and there is no need to first establish a radio link covering the entire cell.

The invention has been described in connection with example embodiments, including what is presently considered to be the most practical and preferred embodiment. But the invention is not limited to the disclosed embodiments; instead, it is intended to cover modifications and equivalent arrangements included within the scope of the appended claims.

1. A method for handing over a mobile station connection, comprising:
receiving one or more downlink signal quality measurements associated with one or more neighboring base stations;
determining a target base station based on the one or more signal quality measurements;
determining a desired antenna beam from plural antenna beams at the target base station for communicating with the mobile station; and
establishing a handover connection between the target base station and the mobile station using the desired antenna beam at the target base station.

2. The method in claim 1, further comprising:
determining a location of the mobile station, and
determining the desired antenna beam using the determined location.

3. The method in claim 1, wherein the signal quality measurements are for a signal broadcast over an entire cell, further comprising:
establishing a radio link between the target base station and the mobile station using the broadcast signal, and thereafter, determining the desired antenna beam at the target base station, and
reconfiguring the radio link to use the desired antenna beam.

4. The method in claim 3, wherein the radio link is reconfigured from a first phase reference associated with the broadcast signal to a second phase reference associated with the desired antenna beam.

5. The method in claim 1, the further comprising:
requesting from the target base station one or more uplink signal quality measurements associated with the mobile station for multiple antenna beams.

6. The method in claim 5, further comprising:
determining which antenna beam at the target base station is desired for the mobile station connection using the one or more uplink signal quality measurements, and
setting up a radio link between the desired antenna beam and the mobile station.

7. The method in claim 1, wherein the desired antenna beam covers an area where the mobile station is currently located or where the mobile station is predicted to be located.

8. The method in claim 1, wherein the desired antenna beam covers an area closest to where the mobile station is currently located or where the mobile station is predicted to be located.

9. The method in claim 1, wherein the handover is a soft or softer handover.

10. The method in claim 1, wherein the handover is a hard handover.

11. The method in claim 1, wherein the target base station includes one or more first antennas for transmitting a first type of signal using a wide antenna beam, the signal quality of which is detected by mobile stations for purposes of providing downlink signal quality messages and one or more second antennas for transmitting a second type of signal using an antenna beam narrower than the wide antenna beam.

12. A radio network controller for use in establishing a handover connection between a mobile station and a target radio base station, comprising:
a memory for storing one or more downlink signal quality measurements associated with one or more neighboring base stations, and
processing circuitry configured to perform the following:
determine the target base station based on the one or more signal quality measurements stored in the memory;
determine a desired antenna beam from plural antenna beams at the target base station for communicating with the mobile station; and
direct establishment of a handover connection between the target base station and the mobile station using the desired antenna beam at the target base station.

13. The radio network controller in claim 12, wherein the processing circuitry is further configured to:
determine a location of the mobile station based on measurement made by the target base station, and
determine the desired antenna beam using the determined location.

14. The radio network controller in claim 12, wherein the signal quality measurements are for a cell-wide signal that includes multiple antenna beams, the processing circuitry is further configured to:
establish a radio link between the target base station and the mobile station using the cell-wide signal, and thereafter, determine the desired antenna beam at the target base station, and
reconfigure the radio link to use the desired antenna beam.

15. The radio network controller in claim 14, wherein the radio link is reconfigured from a first phase reference associated with the cell-wide signal to a second phase reference associated with the desired antenna beam.

16. The radio network controller in claim 12, wherein the processing circuitry is further configured to:
request from the target base station one or more uplink signal quality measurements associated with the mobile station for multiple antenna beams.

17. The radio network controller in claim 16, wherein the processing circuitry is further configured to:
determine which antenna beam at the target base station is desired for the mobile station connection based on the one or more uplink signal quality measurements associated with the mobile station received from the target base station, and
set up a radio link between the desired antenna beam and the mobile station.

18. The radio network controller in claim 12, wherein the desired antenna beam covers an area where the mobile station is currently located or where the mobile station is predicted to be located.

19. The radio network controller in claim 12, wherein the desired antenna beam covers an area closest to where the mobile station is currently located or where the mobile station is predicted to be located.

20. The radio network controller in claim 12, wherein the handover is a soft or softer handover.

21. The radio network controller in claim 12, wherein the handover is a hard handover.

22. The radio network controller in claim 12, wherein the target base station includes one or more first antennas for transmitting a first type of signal using a wide antenna beam, the signal quality of which is detected by mobile stations for purposes of providing downlink signal quality messages and one or more second antennas for transmitting a second type of signal using an antenna beam narrower than the wide antenna beam.

23. A communications system incorporating the radio network controller in claim 11.

24. Apparatus for handing over a mobile station connection, comprising:
means for receiving one or more downlink signal quality measurements associated with one or more neighboring base stations;
means for determining a target base station based on the one or more signal quality measurements;
means for determining a desired antenna beam from plural antenna beams at the target base station for communicating with the mobile station; and
means for establishing a handover connection between the target base station and the mobile station using the desired antenna beam at the target base station.

25. The apparatus in claim 24, further comprising:
means for determining a location of the mobile station, and means for determining the desired antenna beam using the determined location.

26. The apparatus in claim 24, wherein the signal quality measurements are for a signal broadcast over an entire cell, further comprising:
means for establishing a radio link between the target base station and the mobile station using the broadcast signal, and thereafter, determining the desired antenna beam at the target base station, and
means for reconfiguring the radio link to use the desired antenna beam.

27. The apparatus in claim 26, wherein the means for reconfiguring reconfigures the radio link from a first phase reference associated with the broadcast signal to a second phase reference associated with the desired antenna beam.

28. The apparatus in claim 24, the further comprising:
means for requesting from the target base station one or more uplink signal quality measurements associated with the mobile station for multiple antenna beams.

29. The apparatus in claim 28, further comprising:
means for determining which antenna beam at the target base station is desired for the mobile station connection using the one or more uplink signal quality measurements, and
means for setting up a radio link between the desired antenna beam and the mobile station.

30. The apparatus in claim 24, wherein the desired antenna beam covers an area where the mobile station is currently located or where the mobile station is predicted to be located.

31. The apparatus in claim 24, wherein the desired antenna beam covers an area closest to where the mobile station is currently located or where the mobile station is predicted to be located.

32. The apparatus in claim 24, wherein the handover is a soft or softer handover.

33. The apparatus in claim 24, wherein the handover is a hard handover.

34. The apparatus in claim 24, wherein the target base station includes one or more first antennas for transmitting a first type of signal using a wide antenna beam, the signal quality of which is detected by mobile stations for purposes of providing downlink signal quality messages and one or more second antennas for transmitting a second type of signal using an antenna beam narrower than the wide antenna beam.
